(19) United States
(12) Patent Application Publication
(10) Pub. No.: US 2022/0184998 A1
(43) Pub. Date: Jun. 16, 2022

(54) BUILDER'S MEASURING AND MARKING TOOL

(71) Applicant: Swanson Tool Co., Inc., Frankfurt, IL (US)

(72) Inventor: James S. Allemand, Frankfort, IL (US)

(73) Assignee: Swanson Tool Co., Inc., Frankfurt, IL (US)

(21) Appl. No.: 17/117,339

(22) Filed: Dec. 10, 2020

(51) Int. Cl. B43L 7/027; B25H 7/02; G01B 3/56; G01B 3/04

(52) U.S. Cl. CPC B43L 7/0275; G01B 3/04; G01B 3/56; B25H 7/02

(57) ABSTRACT

A measuring and marking tool includes a planar member having a first side edge and a second side edge extending normal to the first side edge, and a third side sedge intersecting the first side edge and the second side edge to form a hypotenuse of a right triangle configuration. A first aperture is space apart inwardly from the third side edge and has a first straight edge parallel to the third side edge and a second straight edge positioned to form an obtuse angle with respect to the first straight edge of the first aperture. A second aperture is spaced apart inwardly from the third side edge and has a first straight edge parallel to the third side edge, and second straight edge spaced apart from the first straight edge of the second aperture, the second straight edge parallel to the second side edge.

### BACKGROUND

### 1. Technical Field

This disclosure relates to the field of measuring and marking tools, such as a trim square for use in construction framework.

### 2. Related Art

In the building industry, there is a need to make measurements and markings on materials in preparation for cutting those materials. Various triangular-shaped tools may be used to allow a user, such as a carpenter, cabinetmaker, construction worker, homeowners/renters, or hobbyists, to make such markings. However, existing builder's measuring and marking tools do not include apertures with extended straight edges along commonly used angular dimensions that allow a user to accurately mark building materials at those common dimensions.

### SUMMARY

A builder's measuring and marking tool comprises a planar member including a first side edge and second side edge extending normal to the first side edge, and a third side edge intersecting the first side edge and the second side edge to form a hypotenuse of a right triangle configuration. The planar member further includes a first aperture spaced apart inwardly from the third side edge, the first aperture having a first straight edge parallel to the third side edge, and a second straight edge positioned to form an obtuse angle with these to the first straight edge of the first aperture. The planar member further includes a second aperture spaced apparat inwardly from the third side edge having a first straight edge parallel to the third side edge, and a second straight edge spaced apart from the first straight edge of the second aperture, the second straight edge parallel to the second side edge.

Yet other builder's measuring and marking tools comprise a planar member having a right triangle configuration including a first side edge, a second side edge extending normal to the first side edge, and a third side edge intersecting the first side edge and the second side edge to form a hypotenuse of the right triangle configuration. The planar member having a first aperture generally in the form of a triangle having a first straight edge intersecting a second straight edge, and a third straight edge intersecting the first straight edge and the second straight edge and forming the hypotenuse of the generally triangular first aperture. The first straight edge of the first aperture spaced apart inwardly and parallel to the third side edge of the planar member. The planar member further having a second aperture in the form of a quadrilateral having a first straight edge spaced apart inwardly and parallel to the third side edge of the planar member, and a second straight edge opposite the first straight edge of the second aperture, the second straight edge parallel to the second side edge of the planar member.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The present disclosure can be better understood with reference to the following drawings and description, including various embodiments which are illustrated in the figures and associated descriptions filed herewith. The components in the figures are not necessarily to scale, emphasis instead being placed upon illustrating the principles of the invention. In the figures, like-referenced numerals designate corresponding parts throughout the different views.

FIG. 1 is a plan view of a builder's measuring and marking tool.

FIG. 2 is a partial elevation view of the builder's measuring and marking tool of FIG. 1.

FIG. 3 is a perspective view of the builder's measuring and marking tool of FIG. 1.

### DETAILED DESCRIPTION

Various aspects are described below with reference to the drawings in which like elements generally are identified by like numerals. The relationship and functioning of the various elements of the aspects may be better understood by reference to the following detailed description. However, aspects are not limited to those illustrated in the drawings or explicitly described below. It should be understood that the drawings are not necessarily to scale, and in certain instances details may have been omitted that are not necessary for an understanding of aspects disclosed herein, such as conventional fabrication and assembly. In this disclosure, the use of the disjunctive is intended to include the conjunctive. The use of definite or indefinite articles is not intended to indicate cardinality.

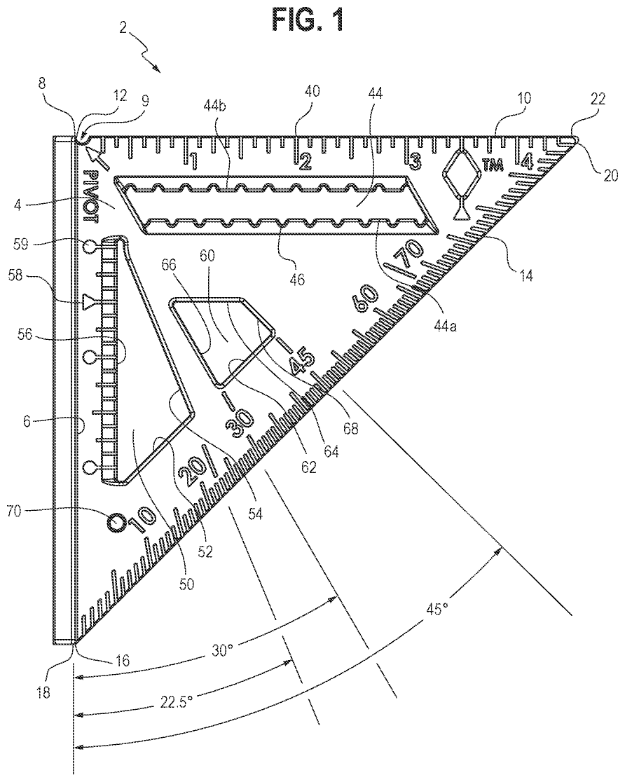

FIG. 1 is an illustration of a builder's measuring and marking tool 2. As shown in FIG. 1, the builder's measuring and marking tool 2 includes a planar member 4 having a right triangle peripheral configuration. As depicted in FIG. 1, this configuration includes a first side edge 6 having a first end 8 which intersects at a right angle with a second side edge 10 at its first end 12, forming a pivot point 9. Planar member 4 also has a third side edge 14 forming the hypotenuse of the right triangle tool 2 with opposite ends 16 and 20. The third side edge 14 is intersected at one end 16 by the first side edge 6 at its opposite end 18 and at the opposite end 20 by the second side edge 10 at its opposite end 22.

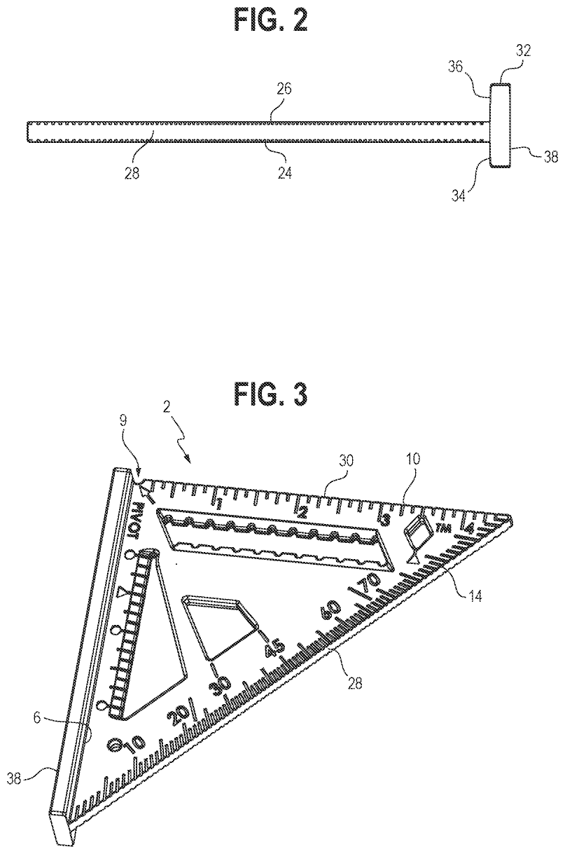

The builder's measuring and marking tool 2 has a first planar surface 24 facing in one direction and a second planar surface 26 facing in the opposite direction, such surfaces being parallel and spaced apart, for example a distance of about three sixteenths to a quarter of an inch, as shown in FIG. 2. A first smooth straight edge wall surface 28 extends between such planar surfaces along the second side edge 10 to provide a marking edge along which a pencil can be drawn to mark a straight smooth line. A second smooth straight edge wall surface 30 (as referenced in FIG. 3) extends between the planar surfaces along the third side edge 14 to also provide a smooth marking edge along that side of the builder's measuring and marking tool 2, and may have a similar thickness to the first smooth straight edge wall surface 28. Various processes and materials may be used to create the measuring and marking tool 2. For example, the measuring and marking tool 2 could be formed by way of a die casting process. Alternatively, the tool could be formed through a molding process using a plastic or other substantially rigid material. The first and second smooth straight edge wall surfaces, 28 and 30, respectively, can be formed by milling the edge wall surfaces to a smooth surface.

As shown in FIG. 2, a T bar 32 is provided along the first side edge 6, having a first ledge 34 with a planar surface extending outwardly a short distance of about a fourth of an inch from and normal to the first planar surface 24 facing inwardly there toward, and a second ledge 36 with a planar surface extending outwardly a short distance of about three-eighths of an inch from and normal to the second oppositely facing planar surface 26 facing inwardly there toward. The T bar 32 has an oppositely facing planar surface 38 facing outwardly and away from the tool 2. These dimensions for the first and second ledges 34 and 36 are only illustrative and are not meant to be limiting. Those skilled in the art will readily recognize that the T bar 32 can have other dimensions as well, and that other projections, lips, or flanges may be used as an abutment edge instead of ledge 34 or ledge 36 to provide a stop against which the first side edge 6 may rest.

Referring again to FIG. 1, the second side edge 10 has distance marking indicia 40 alongside it, starting from the end 12 adjacent end 8 of first side edge 6. In the present embodiment, distance marking indicia 40 are formed on both the first planar surface 24 and second planar surface 26 in one-eighth inch increments and with numerals to indicate each successive inch beginning with the numeral 1 to indicate the first inch away from end 8 of the first side edge 6. These distance marking indicia 40 are only illustrative and are not meant to be limiting, and it is contemplated that other increments could be used within the scope of the builder's measuring and marking tool 2 described herein. Although the exemplary builder's measuring and marking tool 2 depicted in FIG. 1 is illustrated with English measurement units, it will be readily understood that this is not the only measurement scale for implementing the builder's measuring and marking tool 2 of this disclosure. For example, it should be readily understood that the builder's measuring and marking tool 2 may use marking indicia that define other measurement units, such as a metric scale.

The hypotenuse or third side edge 14 may have angle marking indicia 42 formed alongside it on both the first planar surface 24 and second planar surface 26, such as illustrated in FIG. 1. In the present disclosure, the angle marking indicia 42 define a scale of degrees starting from the end 16 of the third side edge adjacent end 18 of first side edge 6 measured about pivot point 9.

The builder's measuring and marking tool 2 in accordance with this disclosure may further include a scribe bar 44 located parallel to the second side edge 10 and spaced apart inwardly therefrom. The scribe bar 44 is bounded by parallel scribing edges 44a and 44b. As illustrated in FIG. 1, for exemplary purposes, scribing edge 44a is spaced inwardly from the second side edge 10 by three-quarters of an inch and scribing edge 44b is spaced inwardly from the second side edge 10 by a half inch. Such positioning places scribing edge 44a at half the thickness of a 2× (e.g., “two-by”) piece of lumber or timber which has a thickness of one and one-half inch, such as a two-by-four, two-by-six, two-by-twelve, etc. Each scribing edge 44a and 44b may have indentations 46 corresponding to distance marking indicia 40 formed along the second side edge 10. As illustrated in FIG. 1, for exemplary purposes, successive indentations 46 alternate between the scribing edges 44a and 44b to define increments of about one-eighth of an inch between successive indentations 46. This configuration also defines about one-fourth of an inch increments between adjacent indentations 46 formed in either of scribing edges 44a and 44b. The dimension for positioning of the scribing edges 44a and 44b of the scribe bar 44, as well as the increments of the indentations 46 of the scribe bar 44 are only illustrative, and are not meant to be limiting. Those skilled in the art will readily recognize that the positioning of the scribe bar 44, and the increments of the indentations 46 of the scribe bar 44 can be other than the dimensions (or scale) described above.

The builder's measuring and marking tool 2 in accordance with this disclosure also includes a first aperture 50. This first aperture 50 includes a first straight edge 52 parallel to the hypotenuse or third side edge 14 of the builder's measuring and marking tool 2, and is spaced apart inwardly therefrom, for example a distance of about three-quarters of an inch. As illustrated in FIG. 1, first aperture 50 includes a second straight edge 54 positioned to form an obtuse angle with respect to the first straight edge 52. For example, and without limitation, as illustrated in FIG. 1, the obtuse angle measures approximately 112 degrees. As further illustrated in FIG. 1, the second straight edge 54 of the first aperture 50 is positioned at about 22.5 degrees with respect to the first side edge 6 about pivot point 9 of the builder's measuring and marking tool 2, and is longer in length than the length of the first straight edge 52, which provides an easy way for the user to the builder's measuring and marking tool 2 to use the second straight edge as a guide to mark a piece of material with a line along the about 22.5 degree angle when the builder's measuring and marking tool 2 is laid flat on top of the piece of material.

The first aperture 50 also includes a third straight edge 56 that is spaced apart from and parallel to the first side edge 6 of the builder's measuring and marking tool 2. As illustrated in FIG. 1, and without limitation, the third straight edge 56 is positioned about three-eighths of an inch from the first side edge 6 of the builder's measuring and marking tool 2. An indicia 58 may be denoted adjacent the third straight edge 56 to denote a distance from the second side edge 10 consistent with a conventional thickness of a piece of lumber or timber. As illustrated in FIG. 1, indicia 58 is positioned one and one-half inches from the second side edge 10, which is a thickness of a piece of lumber or timber typically referred to as a two-by, as explained above. As depicted in FIG. 1, first aperture 50 is shown as having a generally triangular shape despite that aperture 50 may include vertices with generally rounded corners or a vertex connected by a generally extended rounded corner, such as where second straight edge 54 and third straight edge 56 connect in FIG. 1. The addition of such an extended rounded corner permits a user to mark a piece of material at the first indicia 59 along third straight edge 56, which as depicted in FIG. 1 is positioned at one-inch from the second side edge 10. Although first aperture 50 is depicted in FIG. 1 as having a generally triangular shape, this shape is only illustrative and not meant to be limiting. For example, first aperture 50 could have other shapes, such as a quadrilateral, triangle with one or more pointed vertices, or other shapes.

The builder's measuring and marking tool 2 in accordance with this disclosure may also include a second aperture 60. This second aperture 60 may include a first straight edge 62 parallel to the hypotenuse or third side edge 14 of the builder's measuring and marking tool 2, and is spaced apart inwardly therefrom, for example a distance of about three-quarters of an inch. As illustrated in FIG. 1, first aperture includes a second straight edge 64 spaced apart from the first straight edge 62. This second straight edge 64 is parallel to the second side edge 10 of the builder's measuring and marking tool 2, and spaced apart inwardly therefrom at a distance that corresponds to a standard thickness for a piece of lumber or timber. In some configurations, this distance may be one and one half inches, which corresponds to the nominal (in name only) thickness of a piece of lumber or timber commonly referred to as a two-by, as described above. In other configurations, this distance could be about one and one-fourth inches, which corresponds to the nominal thickness of a piece of lumber or timber commonly referred to as having a one and one-half inch thickness, or this distance could be one inch, which corresponds to the nominal thickness of a piece of lumber or timber commonly referred to as having a one inch thickness, or this distance could be another distance corresponding to a nominal thickness of a piece of lumber or timber.

As depicted in FIG. 1, the second aperture 60 includes a third straight edge 66 and a fourth straight edge 68, such that in combination with the first straight edge 62 and second straight edge 64 the second aperture 60 forms a quadrilateral shaped opening. As depicted in FIG. 1, the third straight edge 66 and the fourth straight edge 68 are space apparat at different angles with respect to the first side edge 6 of the builder's measuring and marking tool 2. For example, in FIG. 1, the third straight edge 66 of the second aperture 60 is positioned at about 30 degrees with respect to the first side edge 6 of the builder's measuring and marking tool 2 about pivot point 9, and the fourth straight edge 68 of the second aperture 60 is positioned at about 45 degrees with respect to the first side edge 6 of the builder's measuring and marking tool 2 about pivot point 9. It is contemplated that each of the third straight edge 66 and the fourth straight edge 68 of the second aperture 60 extend inwardly away from the third side edge of hypotenuse 14 of the builder's measuring and marking tool 2, such that a user can use either of the third straight edge 66 or the fourth straight edge 68 as a guide to mark a piece of material with a line along the respective angles of these straight edges when the builder's measuring and marking tool 2 is laid flat on top of the piece of material.

The measuring and marking tool 2 may also include a circular aperture 70 that extends through the first planar surface 24 to its second planar surface 26. Circular aperture 70 may be used with a writing instrument to mark a location on a piece of material into which a fastener, including, without limitation, a screw, nail, bolt, rivet, or other fastener can be affixed. The writing instrument may include, without limitation, a pencil, pen, marker, or other instrument with which a mark may be denoted on a material when extended through circular aperture 70. On some builder's measuring and marking tools 2, circular aperture 70 may have a diameter of about one-eighth of an inch. Other builder's measuring and marking tools 2 may have a circular aperture 70 with a larger or smaller diameter. As shown in FIG. 1, circular aperture is spaced apart inwardly from the first side edge 6 and third side edge 14, and has its center located three and a half inches from the second side edge 10.

FIG. 3 illustrates a perspective view of the builder's measuring and marking tool of FIG. 1.

The specific descriptions of this disclosure are for the purpose of illustrating the manner in which the aspects of the present disclosure are used. It should be understood that the implementation of other variations and modifications of embodiments disclosed herein and their various aspects will be apparent to one skilled in the art, and that the invention in not limited by the specific embodiments described, and it is therefore intended that this disclosure include all such variations and modifications as fall within the scope of the following claims and equivalents thereof.

I claim:

1. A builder's measuring and marking tool comprising:
a planar member including a first side edge and a second side edge extending normal to the first side edge, and a third side edge intersecting the first side edge and the second side edge to form a hypotenuse of a right triangle configuration;
a first aperture spaced apart inwardly from the third side edge, the first aperture having a first straight edge parallel to the third side edge, and a second straight edge positioned to form an obtuse angle with respect to the first straight edge of the first aperture; and
a second aperture spaced apart inwardly from the third side edge having a first straight edge parallel to the third side edge, and a second straight edge spaced apart from the first straight edge of the second aperture, the second straight edge parallel to the second side edge.

2. The builder's measuring and marking tool, further comprising degree measurement marking indicia formed along the third side edge.

3. The builder's measuring and marking tool of claim 1, where the second straight edge of the first aperture is longer in length than the first straight edge of the first aperture.

4. The builder's measuring and marking tool of claim 1, where the second straight edge of the first aperture is positioned at approximately a 22.5 degree angle with respect to the first side edge about a pivot point at an intersection of the planar member's first side edge and second side edge.

5. The builder's measuring and marking tool of claim 1, where the second aperture comprises a third straight edge connecting the first straight edge of the second aperture and the second straight edge of the second aperture, and where the third straight edge of the second aperture is positioned at approximately a 30 degree angle with respect to the first side edge about a pivot point at an intersection of the planar member's first side edge and second side edge.

6. The builder's measuring and marking tool of claim 1, where the second aperture comprises a third straight edge connecting the first straight edge of the second aperture and the second straight edge of the second aperture, and where the third straight edge of the second aperture is positioned at approximately a 45 degree angle with respect to the first side edge about a pivot point at an intersection of the planar member's first side edge and second side edge.

7. The builder's measuring and marking tool of claim 1, where the second straight edge of the second aperture is positioned approximately one and one-half inches inward from the second side edge.

8. The builder's measuring and marking tool of claim 1, where the first aperture comprises a generally triangular shape.

9. The builder's measuring and marking tool of claim 1, where the first aperture comprises a quadrilateral shape.

10. The builder's measuring and marking tool of claim 1, where the second aperture comprises a quadrilateral shape.

11. The builder's measuring and marking tool of claim 1, further comprising a circular aperture spaced apart from the first side edge, the second side edge, and the first aperture.

12. The builder's measuring and marking tool of claim 11, where a diameter of the circular aperture is approximately one-eighth of an inch.

13. The builder's measuring and marking tool of claim 1, further comprising an abutment surface extending away from a planar surface of the planar member, the abutment surface positioned adjacent the first side edge.

14. The builder's measuring and marking tool of claim 1, further comprising distance marking indicia formed along the second edge for marking a distance from the first side edge.

15. A builder's measuring and marking tool comprising:
a planar member having a right triangle configuration including a first side edge, a second side edge extending normal to the first side edge, and a third side edge intersecting the first side edge and the second side edge to form a hypotenuse of the right triangle configuration;
a first aperture generally in the form of a triangle having a first straight edge intersecting a second straight edge, and a third straight edge intersecting the first straight edge and the second straight edge and forming the hypotenuse of the generally triangular first aperture, the first straight edge spaced apart inwardly and parallel to the third side edge of the planar member; and
a second aperture in the form of a quadrilateral having a first straight edge spaced apart inwardly and parallel to the third side edge of the planar member, and a second straight edge opposite the first straight edge, the second straight edge parallel to the second side edge of the planar member.

16. The builder's measuring and marking tool of claim 15, where the second straight edge of the first aperture is longer in length than the first straight edge of the first aperture.

17. The builder's measuring and marking tool of claim 15, where an angle between the first straight edge of the first aperture and the second straight edge of the first aperture is an obtuse angle.

18. The builder's measuring and marking tool of claim 15, where a third straight edge of the second aperture forms an angle of approximately 30 degrees with respect to the first side edge of the planar member about a pivot point at an intersection of the planar member's first side edge and second side edge.

19. The builder's measuring and marking tool of claim 15, where a third straight edge of the second aperture forms an of approximately 45 degrees with respect to the first side edge of the planar member about a pivot point at an intersection of the planar member's first side edge and second side edge.

20. The builder's measuring and marking tool of claim 15, where a third straight edge of the second aperture and a fourth straight edge of the second aperture are spaced apart at different angles with respect to the first side edge of the planar member about a pivot point at an intersection of the planar member's first side edge and second side edge.
